(19) United States
(12) Patent Application Publication
(10) Pub. No.: US 2004/0143617 A1
(43) Pub. Date: Jul. 22, 2004

(54) Method and system for encoding and fast-convergent solving general constrained systems

(76) Inventors: Wolf Kohn, Seattle, WA (US); Vladimir M. Brayman, Mercer Island, WA (US)

Correspondence Address: OLYMPIC PATENT WORKS PLLC, P.O. BOX 4277, SEATTLE, WA, 98104, US

(21) Appl. No.: 10/693,623

(22) Filed: Oct. 23, 2003

Related U.S. Application Data
(60) Provisional application No. 60/420,920, filed on Oct. 23, 2002.

(51) Int. Cl. G06F 7/38

(52) U.S. Cl. 708/446

(57) ABSTRACT

The present invention provides a method and system that produces a near-optimum schedule in linear time by providing an optimal resource ordering scheme. The present invention is embodied in a scheduling computer program.

### CROSS-REFERENCE TO RELATED APPLICATION

This application claims the benefit of provisional patent application No. 60/420,920, filed Oct. 23, 2002.

### TECHNICAL FIELD

The present invention relates to optimization methodologies and, in particular, to a method and system for encoding a class of constrained optimization problems, and then employing a generic, meta-level, iterative optimization technique to solve the encoded class of constrained optimization problems.

### BACKGROUND OF THE INVENTION

It is well known that scheduling of scarce nonrenewable resources subjected to constraints is an NP-hard problem. Suppose that there is a set of tasks W and there is a set of N resources that can be assigned to tasks w e W. The problem that needs to be addressed is to schedule the N resources among the W tasks in an optimal or near optimal manner. Assume u_{w}ⁱ(t) to be a piecewise constant function of the assignment of resources i to task w. Assume d^{w}(t) to be a piecewise constant function of the demand for resources for task w. Then the optimization problem is as follows:

$${min}_{{u}_{w}^{i} ( t ) , … , {u}_{w}^{N} ( t )} {\sum }_{w ∈ W} {\int }_{0}^{T} {c}_{w} ( t ) \vert {d}^{w} ( t ) - {\sum }_{i = 1}^{N} {u}_{w}^{i} ( t ) \vert ⅆ t$$

where c_{w}(t) is a time-varying cost of not satisfying demand for task w.

### SUMMARY OF THE INVENTION

The present invention provides a method and system that produces a near-optimum schedule in linear time by providing an optimal resource ordering scheme.

### DETAILED DESCRIPTION OF THE INVENTION

The present invention is embodied in a computer program that, using a state vector definition and a defined cost-go-go function, optimally orders resources for scheduling.

Define a state vector x_{w}^{k}(t) as follows:

x_{w}^{k+1}(t)=x_{w}^{k}(t)+u_{w}^{k}(t),

x_{w}¹(t)=0,

x_{w}²(t)=u_{w}¹(t),

wεW

The optimization problem described above then becomes:

φ(x_{w}^{N}(t))

subject to the above definition for x_{w}^{k}(t) where

$$φ ( {x}_{w}^{N} ( t ) ) \text{:} = {\sum }_{w ∈ W} {\int }_{0}^{T} {c}_{w} ( t ) \vert {d}^{w} ( t ) - {x}_{w}^{N} ( t ) \vert ⅆ t$$

Define a cost-to-go function V(x_{w}^{N}(t),k)

V(x_{w}^{N}(t),k):={φ(x_{w}^{N}(t))}

x_{w}^{N}(t)=y(t)

Then by Bellman's principle of optimality,

V(y,k):={V(y(t)+u_{w}^{k}(t)),k+1}

x_{w}^{N}(t)=y(t)

V(x_{w}^{N}(t),N):=φ(x_{w}^{N}(t))

Optimal ordering of resources is based on the following weighting function:

ζ₁ƒ₁ⁱ+ζ₂ƒ₂ⁱ

where ζ₁ and ζ₂ are relative weight coefficients, ƒ₁ⁱ is a variable that defines how a user values resource i, and ƒ₂ⁱ is a variable that defines an actual cost of resource i.

The resources are arranged based on the respective values of the weighting function in such a way that the resources with the smallest values go first.

1. A method for scheduling scare, nonrenewable resources, the method comprising:
defining a state vector;
defining a cost-to-go function; and
using Bellman's principle of optimality, optimizing the scheduling by optimally ordering the resources by a weighting function.
